(19) United States
(12) Patent Application Publication
(10) Pub. No.: US 2017/0029060 A1
(43) Pub. Date: Feb. 2, 2017

(54) TRICYCLE KICK SCOOTER

(71) Applicant: MSKI Corporation, Seoul (KR)

(72) Inventor: Jungtae KIM, Goyang-si (KR)

(73) Assignee: MSKI CORPORATION, Seoul (KR)

(21) Appl. No.: 15/303,206

(22) PCT Filed: Apr. 11, 2014
(86) PCT No.: PCT/KR2014/003153

§ 371 Date: Oct. 10, 2016

(51) Int. Cl. B62K 5/10; B62M 1/00; B62K 5/02; B62K 21/12; B62K 5/06

(52) U.S. Cl. CPC B62K 5/10; B62K 21/12; B62K 5/06; B62K 5/02; B62M 1/00

(57) ABSTRACT

The present invention relates to a kick scooter (kickboard), which is a kind of human-powered land vehicle. More specifically, the present invention relates to a tricycle kick scooter including one front wheel and two rear wheels, the tricycle kick scooter comprising: a vertical frame; a pair of left and right horizontal frames; and a connection part, wherein the connection part comprises: a vertical frame support pipe; a connection plate; a tilting shaft; a pressing bar; a tilting shaft bearing; a pressing room; a pressing partition; a pressing elastic body; and an unfolding shaft part.

### TECHNICAL FIELD

The present invention relates to a kick scooter (a kickboard), which is a kind of a human-powered land vehicle.

More specifically, the present invention relates to a tricycle kick scooter including one front wheel configured to carry out a steering (a direction change), and two rear wheels configured in the form of an inclined caster (or a directional property caster), thus providing a propulsive force.

A rider repeatedly does a spreading action (on the contrary, a narrowing action), thus producing a propulsive force.

In the present invention, the aforementioned device is called a tricycle kick scooter.

### BACKGROUND ART

As a conventional technology of the present invention, there is the Korean patent laid-open number 46353 (Jun. 12, 2003).

The aforementioned patent is equipped with a configuration and means to incline a rider's body leftward or rightward when changing the riding direction, by which the centrifugal force can be overcome during a direction change cornering action.

The aforementioned patent is not equipped with any configuration to make a propulsive force while spreading the feet of the rider, for which it is impossible to produce a propulsive force by itself.

Moreover, there is provided the Korean patent registration number 893678 (Apr. 9, 2009).

The aforementioned patent is equipped with a configuration and means to produce a propulsive force in such a way that the feet of the rider is spread out.

Since the direction change in the leftward and rightward directions, however, should be carried out in a state where the rotary shaft of a handle stands upward vertically, the rider is not able to have a posture during the change of the direction in order for the rider to withstand the centrifugal force, and the rider's body may be leaned toward the outward direction in case of a cornering action, so the rider may be at risk to be capsized (tumble). In this case, the rider should slow down.

Meanwhile, there is the Korean patent registration number 949145 (Mar. 16, 2010) which allows to implement both the handling and cornering along with a free direction change while improving the aforementioned problems. In this patent, the propulsive force can be produced in such a way to spread out the feet of the rider while the body of the rider is tilted in the leftward and rightward directions during the direction change cornering action.

### DISCLOSURE OF INVENTION

### Technical Problem

In case of the patent number 949145, there is provided a joint part which may allow a leftward and rightward inclining, namely, tilting of a vertical frame (referred to a handle rod) in terms of its configuration; however a spring device is exposed to the outside, which is configured to help the returning to its original position in a vertical state after the tilting.

This structure may cause an unexpected accident during the actual operation. For example, a part of the rider's body may contact with a spring which is in operation or a peripheral component, thus causing an accident. In worse case, there may be a risk wherein a finger is stuck and cut off.

In addition, the configuration to allow the vertical frame to tilt seems the most important feature; however since it is exposed to external rain and wind, dust, etc., it needs to frequently clean the vertical frame for the sake of a good looking exterior, which may cause an uneasy management.

The patent number 949145 has a disadvantageous condition in terms of manufacturing. The aforementioned patent needs a plurality of expensive coil springs. In the configuration to mount each coil spring, the device may be complicated, and the manufacturing cost is high. This configuration has a bad durability.

### DISCLOSURE OF INVENTION

Accordingly, it is an object of the present invention to provide a tricycle kick scooter. To achieve the above object, there is provided a tricycle kick scooter, which include:

a vertical frame which is equipped with a handle and a front wheel and stands upright;

a connection part which is disposed at an intermediate portion of the vertical frame; and

a pair of left and right horizontal frames the front end of which is hinged to the connection part, and the rear end of which is equipped with a foot rest and a rear wheel, wherein

the kick scooter can be driven in such a way that the vertical frame is tilted left and right, and at the same time, the horizontal frames are spread out horizontal, and

wherein the connection part may include

a vertical frame support tube to which the vertical frame is pivotally engaged; a connection plate the front side of which is attached to a rear end of the vertical frame support tube; a tilting shaft which extends from the center of a rear end of the connection plate to the rear side; a pair of left and right pressing bars which are disposed at the left and right sides of the tilting shaft and extend from the back side of the connection plate to the rear side;

a tilting shaft support rest which is configured to axially support the tilting shaft; a pressing room which allows for a space at the surrounding of the tilting shaft support rest for the pressing bar to be interposed; a pressing partition which partitions the pressing room; a pressing elastic body which is a compressible and expandable elastic member and is interposed between the pressing partition and the pressing bar; and a horizontal frame spreading shaft part which is formed extending from the left and right sides of the pressing room and is equipped with a spreading shaft which is able to axially support the front end of the horizontal frame.

### Advantageous Effects of the Invention

The present invention has a structure,

wherein the configuration of a major component operating about an elastic body of a connection part is hidden inside, wherein the elastic body is able to return the vertical frame to its original position after it has been inclined and tilted in the left and right directions,

whereby the tilting of the vertical frame may be freely carried out, and the vertical frame is able to return to its original position, so there may not be any chance for the human body to contact therewith, whereby it is possible to previously prevent any accident which was likely to happen in the conventional technology.

Moreover, since the vertical frame is hidden and protected from a predetermined attack from an external environment, for example, rain and wind, dust, etc., the management thereof is easy, and a long time storage is available.

In addition thereto, since the joint having a relatively complicated configuration is not exposed to the outside, it is possible to manufacture a tricycle kick scooter which visually provide a good looking exterior.

Furthermore, since a compression elastic body made in a rubber bar type, the manufacturing cost of which is very low, can be directly used after it has been cut into the forms of pieces, so the manufacturing price can be reduced, and the durability of the product can be enhanced since it is manufactured in a relatively simple structure.

### BRIEF DESCRIPTION OF DRAWINGS

FIG. 1 is a perspective view illustrating the whole configuration.

FIG. 2 is a view illustrating a back side (a rear side), wherein “A” is a state view illustrating an original state, “B” is an operation view illustrating a tilting operation of a vertical frame, and “C” is an operation view illustrating a spreading operation of the left and right horizontal frames.

FIG. 3 is a view illustrating a back side, wherein “A” is an operation view illustrating a tilting operation of a vertical frame and a spreading operation of a horizontal frame at one side, and “B” is an operation view illustrating a tilting operation of a vertical frame and a spreading operation of the horizontal frame at both sides.

FIG. 4 is a perspective view illustrating a connection part.

Hereinafter, the illustration of a cap (ca) is omitted.

FIG. 5 is a view illustrating a first unit 300a, wherein “A” is a side view, “B” is a rear view, and “C” is a plane view.

FIG. 6A is a view, wherein “A” is a front view illustrating an example wherein a pressing elastic body of a coil spring type is engaged at a pressing room, and “B” is a partial view.

FIG. 7 is a view illustrating a second unit 300b wherein a bar type pressing elastic body is mounted, wherein the upper side is a plane view, and the lower side is a front view, and

wherein the left side “L” of the central line “c” illustrates a projected state, and the right side “R” illustrates an exterior.

FIG. 8 is a disassembled perspective view illustrating a disassembled state of a first unit and a second unit.

FIG. 9 is a rear view illustrating an assembled state of a first unit and a second unit.

FIG. 10 is an operation view when viewing from the back side the tilting operation with respect to a first unit and a second unit.

FIGS. 11A to 11D are example views for describing various states and embodiments of a pressing elastic body.

FIG. 12 is a view, wherein “A” is a partial plane view illustrating a horizontal frame, and “B” is an engagement view when viewing from the plane a hinged engagement of a connection part and a horizontal frame, provided that the left side “L” of the central line (c) is a projected state, and the right side (R) is an exterior, and “C” is an operation view when viewing from the plane a spreading operation of a horizontal frame.

### BEST MODES FOR CARRYING OUT THE INVENTION

The tricycle kick scooter may include:

a vertical frame which is equipped with a handle and a front wheel and stands upright;

a pair of left and right horizontal frames which are equipped with a foot rest and a rear wheel and are disposed horizontal at a rear side of the vertical frame; and

a connection part which is configured to connect an intermediate portion of the vertical frame and a front end of the horizontal frame,

wherein the kick scooter can be driven in such a way to the horizontal frames are spread out horizontal while simultaneously tilting in the leftward and rightward directions the vertical frame,

wherein the connection part includes a first unit formed of a vertical frame support tube to which the vertical frame is pivotally engaged; a connection plate the front side of which is attached to a rear end of the vertical frame support tube; a tilting shaft which extends from the center of a rear end of the connection plate to the rear side; and a pair of left and right pressing bars which are disposed at the left and right sides of the tilting shaft and extend from the back side of the connection plate to the rear side; and

a second unit formed of a tilting shaft support rest which is configured to axially support the tilting shaft; a pressing room which allows for a space at the surrounding of the tilting shaft support rest for the pressing bar to be interposed; a pressing partition which partitions the pressing room; a pressing elastic body which is a compressible and expandable elastic member and is interposed between the pressing partition and the pressing bar; and a spreading shaft part disposed at a portion where it can extend from the leftward and rightward sides of the pressing room for the horizontal frame to be spread out,

wherein when tilting, the first unit rotates about the tilting shaft with respect to the second unit, and the pressing bar presses the pressing elastic body, and if the pressing is eliminated, it elastically recovers.

### MODES FOR CARRYING OUT THE INVENTION

The preferred embodiments of the present invention will be described in detail with reference to the accompanying drawings.

Referring to FIG. 1, the tricycle kick scooter according to the present invention includes:

a front wheel part 10 which may be provided as a configuration for a direction change and may be formed of

a strut type vertical frame 11 which stands upright; a handle 12 which is engaged to the top of the vertical frame 11 for the sake of an easier grasping with a hand; and a front wheel 13 which is engaged in a rolling manner to the bottom of the vertical frame 11, and

a rear wheel unit 20 which may be provided as a configuration for a driving or propulsive action, and

may include a pair of left and right (L and R) of a horizontal frame 21 which is placed horizontal behind the front wheel part 10 and is formed in a rod shape; left and right foot rests 22 which are engaged to the rear end and the top of the left and right horizontal frames 21 for a user to stand with his feet; and left and right rear wheels 23 which are engaged in a rolling manner to the lower ends of the rear sides of the left and right horizontal frames 21, and

a connection part 300 which may be provided as a configuration to connect the front wheel part 10 and the rear wheel part 20, and

may be disposed at an intermediate portion of the vertical frame 11 and at a front end of the horizontal frame 21, and

may be configured to axially support the body of the vertical frame 11 for the vertical frame 11 to be steered for the sake of a direction change; and to axially support a front end of each of the left and right horizontal frames 21 for the left and right horizontal frames 21 to be spread out in the leftward and rightward directions, and

to incline and tilt the front wheel part 10 in the leftward and rightward directions with respect to the rear wheel part 20.

In addition, there may be further provided a height adjusting means “s1” disposed at the vertical frame 11, wherein the top and bottom height thereof can be adjusted as it slides, and a caliper brake “br” installed at the handle and configured to brake.

Moreover, the horizontal frame 21 may be equipped with a folding means “s2” which can be folded for the sake of easier storage, and the rear heel 23 may be equipped with a typical inclined caster which is related with the propulsive force.

In the operation method, the vertical frame 11 is tilted leftward and rightward, thus offsetting the centrifugal force when changing the direction, and the horizontal frame 21 is spread out horizontal, thus moving forward.

The detailed operation method might be referred to the known method.

The connection part 300 which is considered a major component of the present invention will be described in detail with reference to FIG. 4.

The connection part 300 will be described by separating it into a first unit 300a and a second unit 300b.

Referring to FIGS. 4, 5, 8 and 9,

the first unit 300a may include a vertical frame support tube 310 which is formed in a tubular (a pipe) shape and is inserted into the body of the vertical frame 11 and is pivotally engaged, and

a tilting shaft part 320 which is formed of a connection plate 321 which is formed in a disk (a circular plate) shape the front side of which is attached to a rear end of the vertical frame support tube 310; a tilting shaft 322 which is configured in the form of a rotary shaft and extends from the center of the rear side of the connection plate 321 to the rear side; and a pair of left and right pressing bars 323 which are configured in the form of a bar (a rod and a stick) and are disposed at the left and right sides of the tilting shaft 322 and extend from a rear end of the connection plate 321 to the rear side.

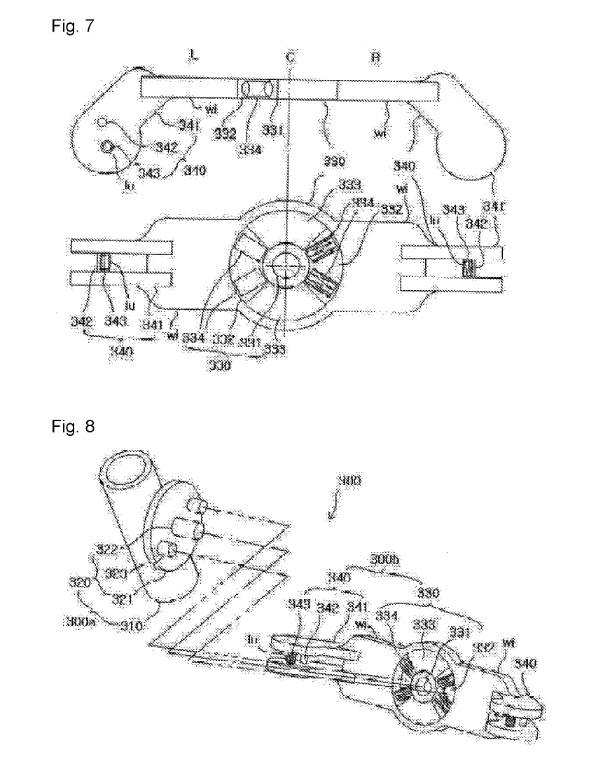

Referring to FIGS. 4, 7, 8 and 9, the second unit 300b may include:

a tilting shaft support part 330 formed of a tilting shaft support rest 331 which is formed in a shaft support shape and is configured to axially support the tilting shaft 322; a pressing room 332 which can be formed by creating a space at the surrounding of the tilting shaft support rest 331, wherein the pressing bar 323 can be disposed therein; a pair of upper and lower pressing partitions 333 which are disposed above and below in the space and partition the space into left and right sections; a pressing elastic body 334 which is made in a bar shape and is formed of four members which expand to their originals states if they have been pressed by an external force, and then the pressed states are eliminated, wherein the four members are interposed between the pressing partition 333 and the pressing bar 323, whereby the pressing elastic body 334 is disposed perpendicular to the pressing bar 323; and a cap “ca” which is engaged to the rear side of the pressing room 332 and is closed to seal the pressing room 332 from the outside, and

a spreading shaft part 340 which is formed of a spreading shaft housing 341 disposed at an end portion extending in the form of a wing “wi” from the left and right sides of the pressing room 332; a spreading shaft 342 which is installed at the spreading shaft housing 341 and is configured to axially support each front end of the left and right horizontal frames 21; and a spreading limiting shaft 343 which is disposed in front of the spreading shaft 342 and is able to limit the spreading of the horizontal frame 21.

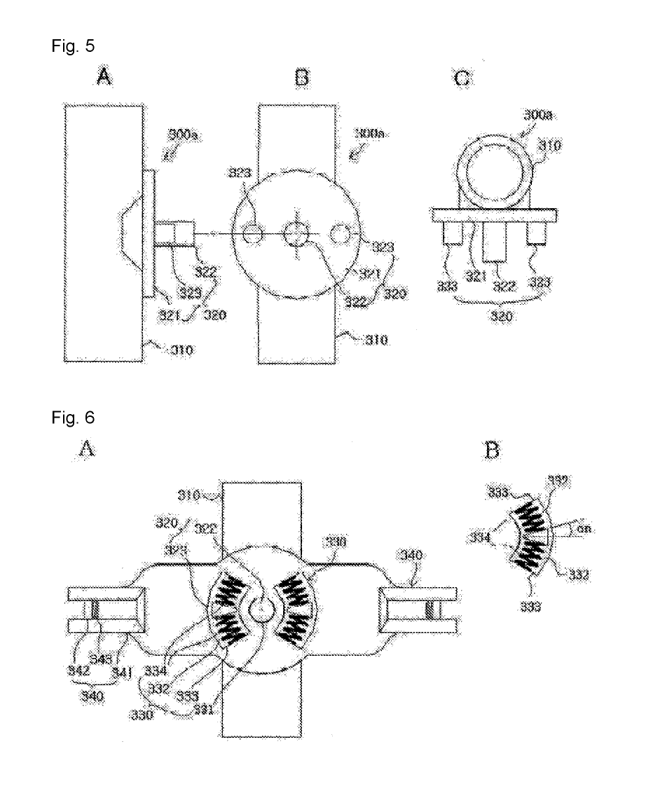

Meanwhile, FIG. 5A is a view illustrating a state where the pressing elastic body 334 of a coil spring type is engaged at the pressing room 332. The pressing elastic body of the coil spring type is incorporated in the pressing room 332, it won't separate if a separate fixing device is not used.

The contact portions of the pressing bar and the pressing elastic body may not all contact with each other. In order to offset this situation, as illustrated in “B”, an angle “an” is set in such a way that the horizontal cross section of the pressing bar forms a triangle by which as illustrated in FIG. 5A, the pressing bar and the end of the pressing elastic body of a coil spring type can accurately contact with each other and are engaged.

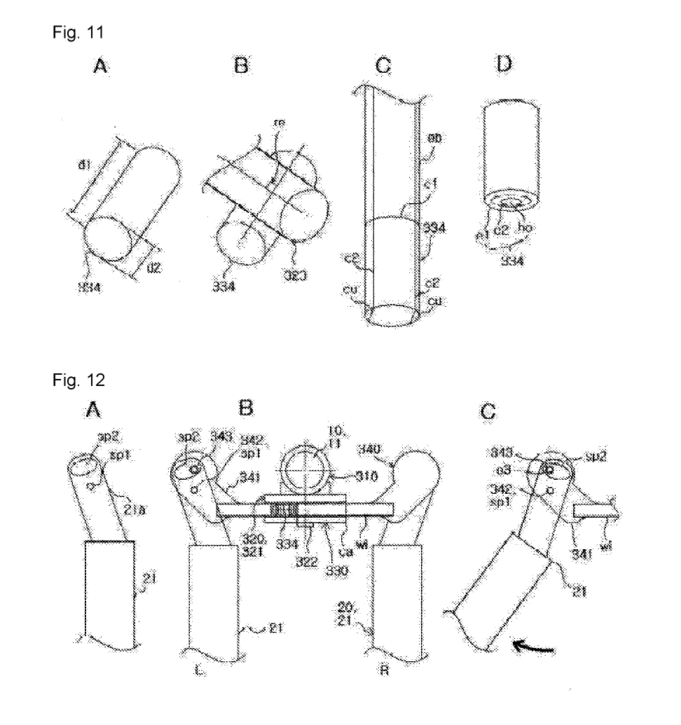

The pressing elastic body 334 will be described more with reference to FIG. 11.

As illustrated in FIG. 11A, it may be provided in the form of a bar which has a length “d1” long enough to be interposed at the pressing room 332 and a diameter “d2” large enough for the vertical frame 11 to be crushed for the sake of substantial tilting and have a pressing elasticity.

The length “d1” and the diameter “d2” may be determined based on the spec, for example, the space size of the pressing room 332 and the tilting permission angle of the vertical frame 11.

The pressing elastic body 334 is provided in the form of bar for the following reason.

As illustrated in FIG. 11B, it may be disposed perpendicular (re) to the pressing bar 323, and then two components of the bar type meet each other in a perpendicular shape. In this state, even though the positions are not accurately matched, the pressing bar 323 can always contact with the body of the pressing elastic body 334, for which it is possible to eliminate any labor to accurately align and dispose the centers, and it does not need to provide a predetermined fixing means.

According to the typical technology configuration, there is a problem in fixing the elastic body, for example, a spring.

The bar shape of the pressing elastic body 334 has the following features in terms of manufacturing.

As illustrated in FIG. 11C, the elastic body provided as a raw material like a long rubber “eb” can be cut “c1” into pieces by a desired length, which may allow for an easier manufacturing, and the manufacturing time can be reduced, and cost is low.

As illustrated in FIG. 11C, the pressing elastic body 334 may be cut “c2” in the vertical direction of the pressing elastic body 334 to remove a predetermined portion thereof, thus forming a cut surface “cu”. In this way, the contacting surface with the pressing bar 323 can be increased. If the contacting surface with respect to the cutting surface increases, the pressing pressure may be distributed over wider area, so the pressure concentrating only on a specific contact point can be reduced, thus enhancing the durability.

The aforementioned feature may become an important matter since a lot of problems occurs due to the low durability of the spring elastic body and the configuration to fix the same in the conventional technology configuration.

Referring to FIG. 11D, the pressing elastic body 334 is referred to a multi-layer structure wherein it is provided in the form of a hollow “ho” rubber tube “e1”, and a rubber tube “e2” having a diameter smaller than that of the same is inserted and interposed. In this case, since a space which will be crushed into the hollow inside can be obtained, a graph curve of a compression resistance can be formed gentler, so it is possible to provide a relatively smooth tilting feeling.

The form of the cutting surface “cu” may be adapted to the rubber tubes “e1” and “e2”. If it is disposed in a multiple layer structure, each advantage can be obtained.

Referring to FIGS. 12A and 12B, at the front end 21a of the horizontal frame,

there may be provided a spreading shaft support rest “sp1” configured to insert the spreading shaft 342; and a spreading limiting groove “sp2” in which the spreading limiting shaft 343 is inserted and interposed, wherein a predetermined space can be defined for the spreading limiting shaft 343 to be movable a little therein.

As illustrated in FIG. 12C, the range wherein the horizontal frame 21 is spread out in the leftward and rightward directions can be limited within a movable range that the spreading limiting groove “sp2” is provided.

The impact which generates when contacting with the rim of the spreading limiting groove “sp2” can be reduced in such a way to cover the rubber tube “e3” on the surrounding of the spreading limiting shaft 343.

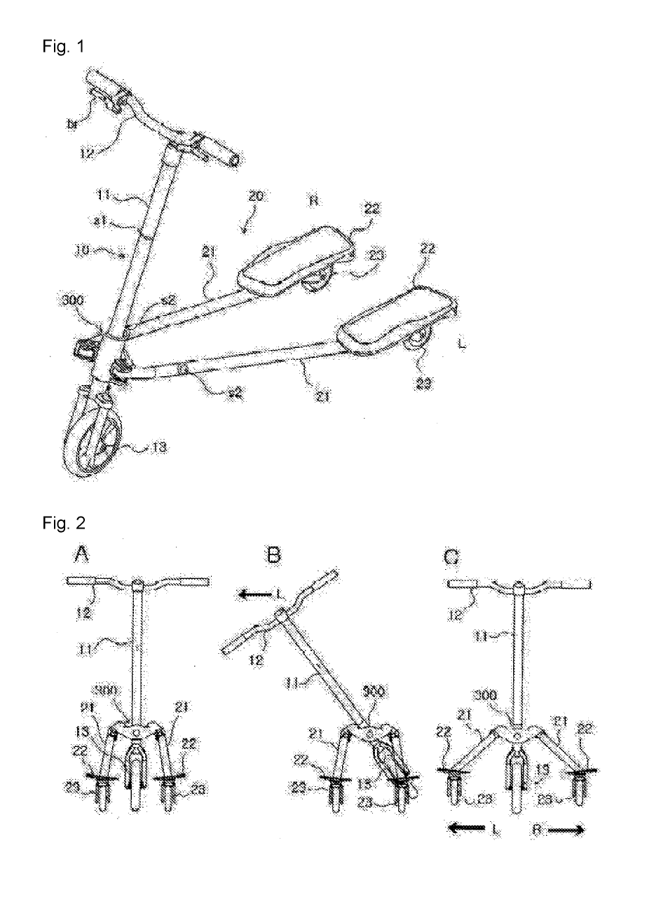

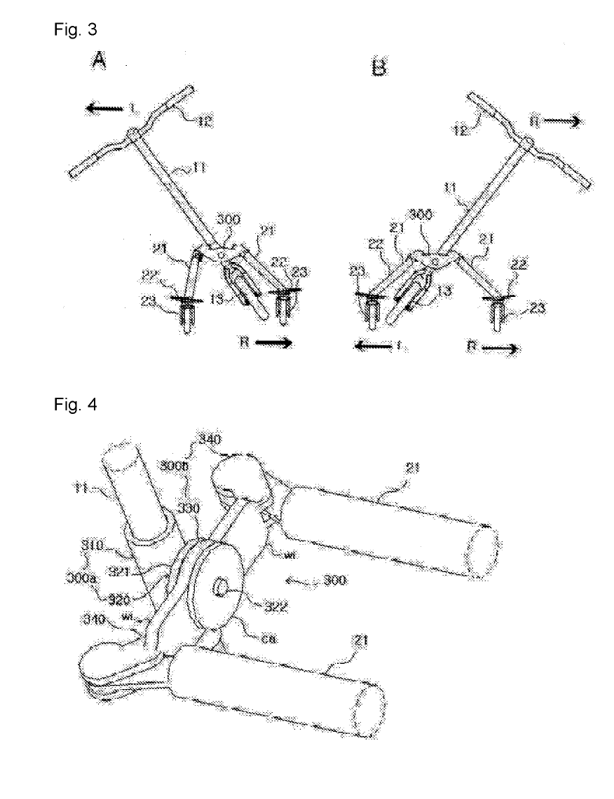

The driving operations in FIGS. 2 and 3 can be carried out since all the aforementioned components collectively operate. More specifically, the vertical frame may be tilted toward the left side “L” as illustrated in FIG. 2B from the originals state as illustrated in FIG. 2A or the horizontal frame may be spread out in the direction of the left and right sides “L” and “R” as illustrated in FIG. 2C.

Referring to FIGS. 3A and 3B, the vertical frame may be tilted leftward and rightward “L” and “R”, and at the same time, the horizontal frame at one side between the leftward and rightward “L” and “R” sides can be spread out toward the left side “L” or the right side “R”. If necessary, all the horizontal frames at the left and right “L” and “R” sides can be all spread out along with the tilting.

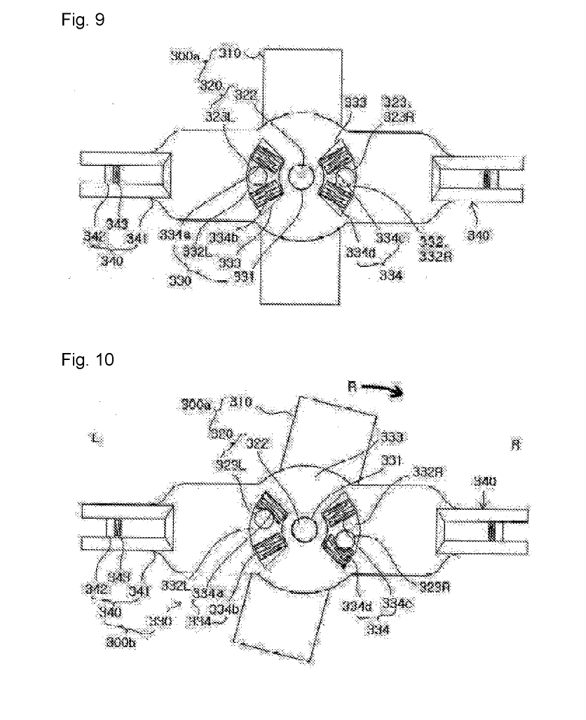

The operation of the connection 300 when the tilting is carried out, will be described in detail with reference to the examples in FIGS. 9 and 10.

If the vertical frame support tube 310 is tilted in the rightward direction “R” along the vertical frame, the first unit 300a will rotate about the tilting shaft 322 with respect to the second unit 300b, and the left pressing bar 323L presses the pressing elastic body 334a of the top at the left side, and the right pressing bar 323R presses the pressing elastic body 334d of the bottom at the right side. At this time, the pressing elastic bodies 334a and 334d are crushed and compressed while applying a resistance to the rotation. Meanwhile, the pressing elastic bodies 334b and 334c at the bottom of the left side and the top of the right side may be in the idle (a resting state) state.

Thereafter, if the pressing is removed, the crushed form of the pressing elastic body can be unfolded, and the first unit will return to its original position with the aid of the elastic recovery force, by which the vertical frame can stand upright.

### INDUSTRIAL APPLICABILITY

According to the present invention,

any accident can be previously prevented as compared to the conventional technology, and

the management is easy, and a long time storage is available, and

the product can be designed to give a visually clean exterior, and

the manufacturing cost can be reduced, and a relatively simple structure can be manufactured, thus enhancing the durability, whereby

the product of the present invention is competitive as compared to the conventional product and can be widely distributed.

1. A tricycle kick scooter, comprising:
a vertical frame which is equipped with a handle and a front wheel and stands upright;
a pair of left and right horizontal frames which are equipped with a foot rest and a rear wheel and are disposed horizontal at a rear side of the vertical frame; and
a connection part which is configured to connect an intermediate portion of the vertical frame and a front end of the horizontal frame, wherein the kick scooter can be driven in such a way to the horizontal frames are spread out horizontal while simultaneously tilting in the leftward and rightward directions the vertical frame,
wherein the connection part comprises a first unit formed of a vertical frame support tube to which the vertical frame is pivotally engaged; a connection plate the front side of which is attached to a rear end of the vertical frame support tube; a tilting shaft which extends from the center of a rear end of the connection plate to the rear side; and a pair of left and right pressing bars which are disposed at the left and right sides of the tilting shaft and extend from the back side of the connection plate to the rear side; and a second unit formed of a tilting shaft support rest which is configured to axially support the tilting shaft; a pressing room which allows for a space at the surrounding of the tilting shaft support rest for the pressing bar to be interposed; a pressing partition which partitions the pressing room; a pressing elastic body which is a compressible and expandable elastic member and is interposed between the pressing partition and the pressing bar; and a spreading shaft part disposed at a portion where it can extend from the leftward and rightward sides of the pressing room for the horizontal frame to be spread out, wherein when tilting, the first unit rotates about the tilting shaft with respect to the second unit, and the pressing bar presses the pressing elastic body, and if the pressing is eliminated, it elastically recovers.

2. The kick scooter of claim 1, wherein the pressing partition is formed at the upper and lower sides of the pressing room, thus partitioning the pressing room into the left and right parts.

3. The kick scooter of claim 1, wherein a spreading shaft housing is formed at the left and right extension portions of the pressing room, and a spreading limiting shaft is together installed at the spreading housing so as to limit the spreading of the spreading shaft part and the horizontal frame.
